(19) United States
(12) Patent Application Publication
(10) Pub. No.: US 2020/0130719 A1
(43) Pub. Date: Apr. 30, 2020

(54) ADJUSTABLE TRANSPORT CART

(71) Applicants: Michael J. SAELI, Orchard Park, NY (US); Frank A. SAELI, JR., Lakeview, NY (US)

(72) Inventors: Michael J. SAELI, Orchard Park, NY (US); Frank A. SAELI, JR., Lakeview, NY (US)

(21) Appl. No.: 16/267,736

(22) Filed: Feb. 5, 2019

Related U.S. Application Data
(60) Provisional application No. 62/753,602, filed on Oct. 31, 2018.

(51) Int. Cl. B62B 3/02

(52) U.S. Cl. CPC B62B 3/02

(57) ABSTRACT

An adjustable cart, including a main frame, including a first side arm and at least one wheel, and a first movable end, including a first connecting bar, a first side bar connected to the first connecting bar, wherein the first side bar is slidably engaged with the side arm in order to adjust a length of the adjustable cart, and an outrigger connected to the first connecting bar.

### CROSS-REFERENCE TO RELATED APPLICATIONS

This application claims the benefit under 35 U.S.C. § 119(e) of U.S. Provisional Application No. 62/753,602, filed Oct. 31, 2018, which application is incorporated herein by reference in its entirety.

### FIELD

The present disclosure broadly relates to a transport cart, more specifically to an adjustable transport cart, and even more particularly to a transport cart having both length and width adjustability.

### BACKGROUND

Transport carts are used to move cargo, equipment, etc. between various locations, e.g., moving cargo from trailer to a train car. Moveable items are placed on the cart and the cart wheels facilitate the subsequent movement of the items from a first location to a second location. Carts must be designed to hold and move items that are light in weight as well as very heavy items. Thus, carts must be constructed to be strong, i.e., capable of supporting large weights. In view of the foregoing, known carts are constructed as fixed sized devices. Moreover, a user typically obtains carts of a variety of sizes so that a variety of cargo or items to be moved can be handled. In short, a different sized cart is needed for each different sized cargo. Alternatively, a user may obtain a standard sized cart and utilize some means to accommodate items of varying size, e.g., building custom decks that are positioned between the cart's upper surface and the items being moved.

As can be derived from the variety of devices and methods directed at moving cargo and items between locations, many means have been contemplated to accomplish the desired end, i.e., convenient and reliable transport systems. Heretofore, tradeoffs between size, cost, and reliability were required. Thus, there is a long-felt need for an adjustable transport cart that can accommodate a variety of sized objects as may be deemed necessary for cost effective manufacturing and transport thereof.

### SUMMARY

According to aspects illustrated herein, there is provided an adjustable cart, comprising a main frame, including a first side arm and at least one wheel, and a first movable end, including a first connecting bar, a first side bar connected to the first connecting bar, wherein the first side bar is slidably engaged with the side arm in order to adjust a length of the adjustable cart, and an outrigger connected to the first connecting bar.

According to aspects illustrated herein, there is provided an adjustable cart, comprising a main frame, including a first side arm having a first slot, a second side arm having a second slot, and one or more wheels, a first movable end, including a first connecting bar, a first side bar connected to the first connecting bar, wherein the first side bar is slidably engaged with the first side arm in order to adjust a length of the adjustable cart, a second side bar connected to the first connecting bar, wherein the second side bar is slidably engaged with the second side arm in order to adjust the length of the adjustable cart, a first outrigger slidably connected to the first connecting bar to adjust a width of the adjustable cart, and a second outrigger slidably connected to the first connecting bar to adjust the width of the adjustable cart.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 includes top plan, front and side elevational, and perspective views of a present adjustable transport cart in a fully closed arrangement;

FIG. 2 includes top plan, front and side elevational, and perspective views of a present adjustable transport cart having the moveable ends in their respective retracted positions and arranged for linear travel relative to the main body frame, i.e., tilted downwardly;

FIG. 3 includes top plan, front and side elevational, and perspective views of a present adjustable transport cart having the moveable ends in their respective extended positions and arranged for linear travel relative to the main body frame, i.e., tilted downwardly;

FIG. 4 includes top plan, front and side elevational, and perspective views of a present adjustable transport cart having the moveable ends in fully extended positions in front and back directions and having the side arms secured in position to the main body frame;

FIG. 5 includes top plan, front and side elevational, and perspective views of a present adjustable transport cart having the moveable ends in fully extended positions in front and back directions, and the outriggers in their respected retracted positions and arranged for linear travel relative to the main body frame, i.e., rotated outwardly;

FIG. 6 includes top plan, side elevational, and perspective views of a present adjustable transport cart having the moveable ends in fully extended positions in front and back directions, and the outriggers in their respected extended positions and arranged for linear travel relative to the main body frame, i.e., rotated outwardly;

FIG. 7 includes top plan, front and side elevational, and perspective views of a present adjustable transport cart having the moveable ends in fully extended positions in front and back directions, and the outriggers are in fully extended positions in left and right directions and secured in position to the main body frame;

FIG. 8 includes top plan, front and side elevational, and perspective views of a present adjustable transport cart in a fully closed arrangement and further including a parts list; and,

FIG. 9 is an exploded perspective view of an embodiment.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodologies, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs. Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

It should be appreciated that the term “substantially” is synonymous with terms such as “nearly,” “very nearly,” “about,” “approximately,” “around,” “bordering on,” “close to,” “essentially,” “in the neighborhood of” “in the vicinity of” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

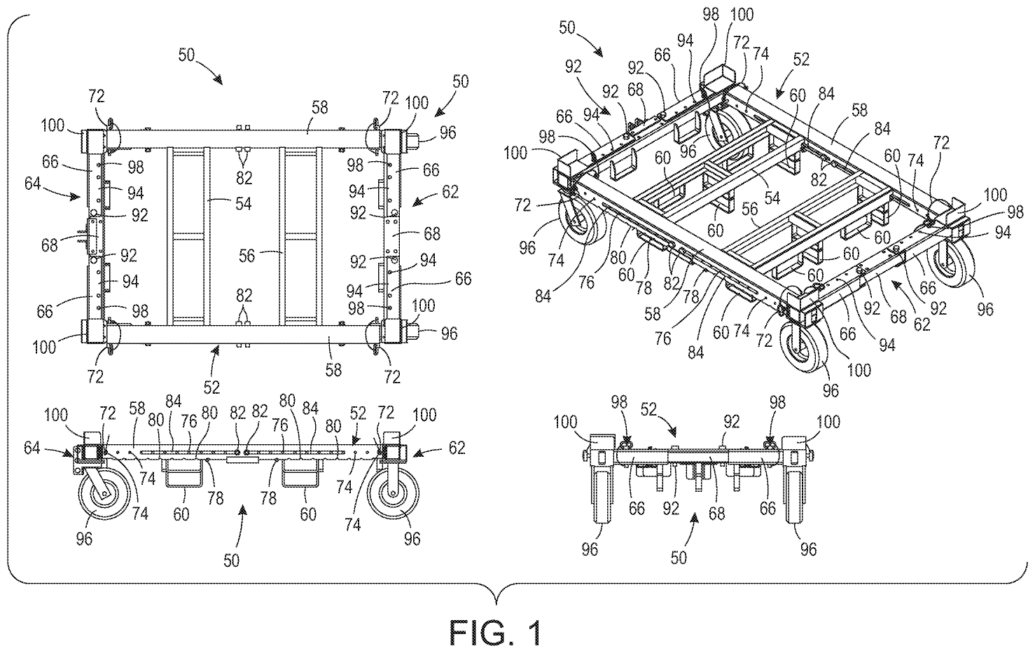

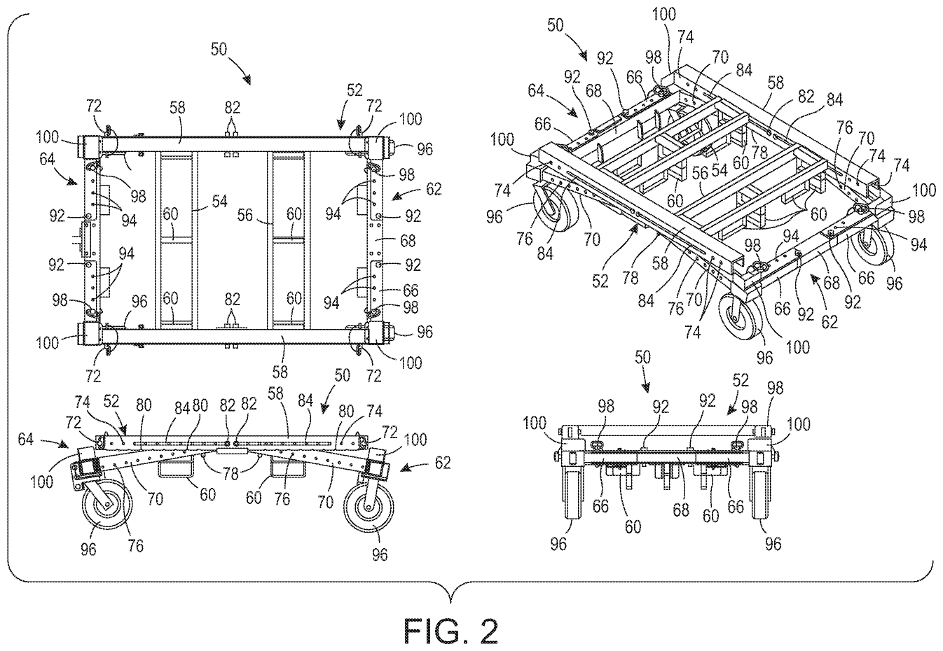

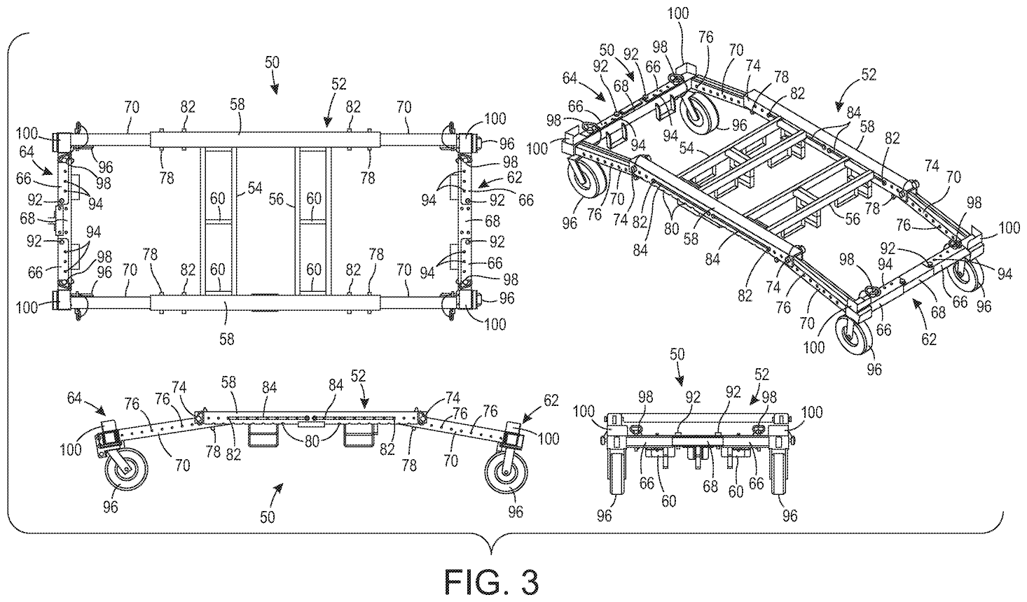

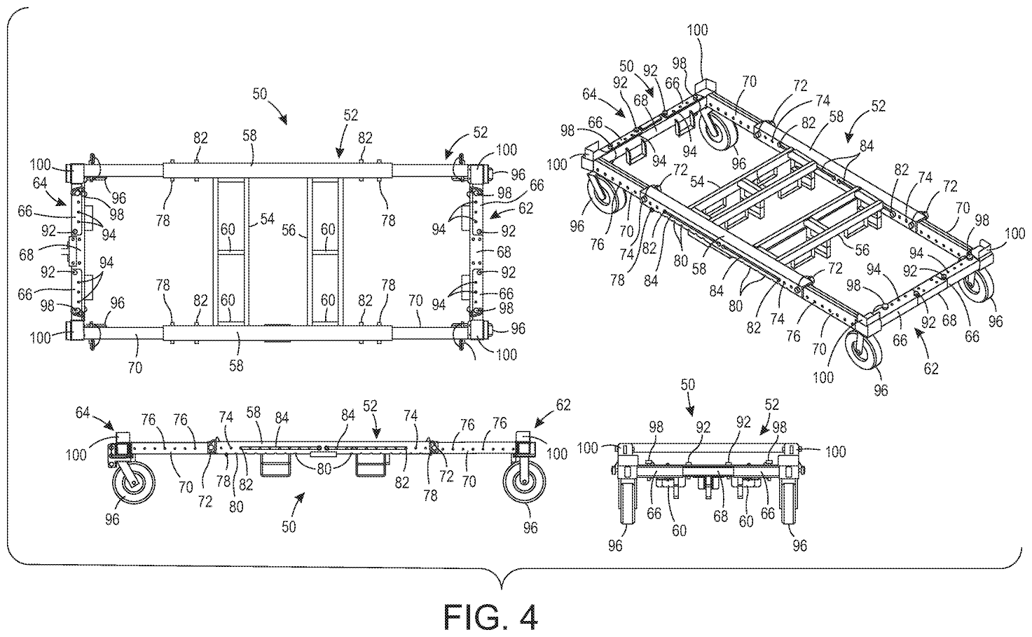

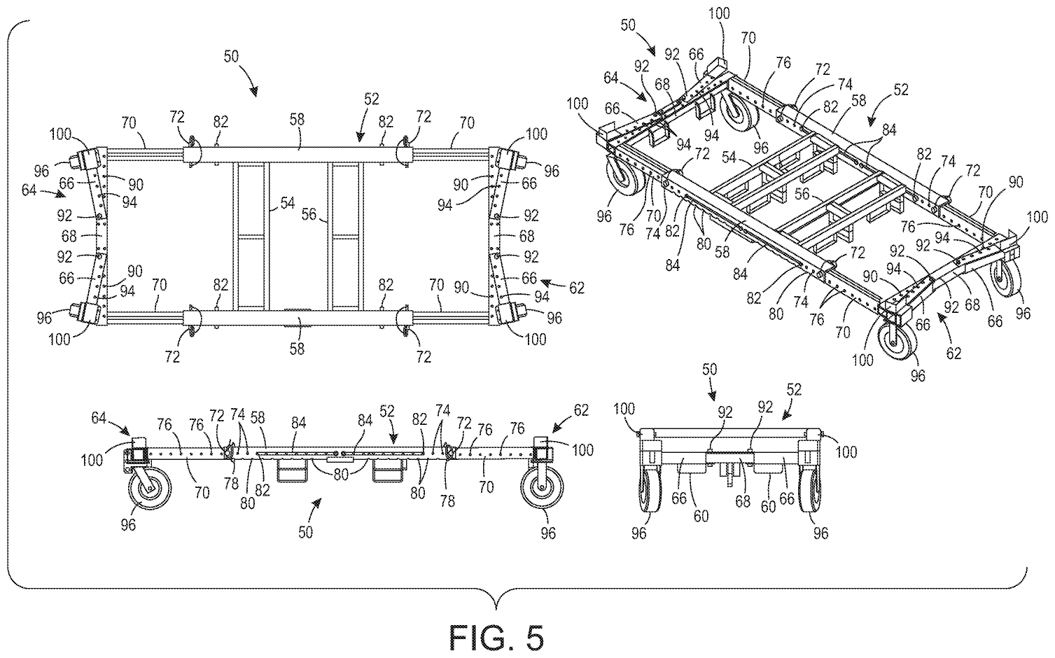

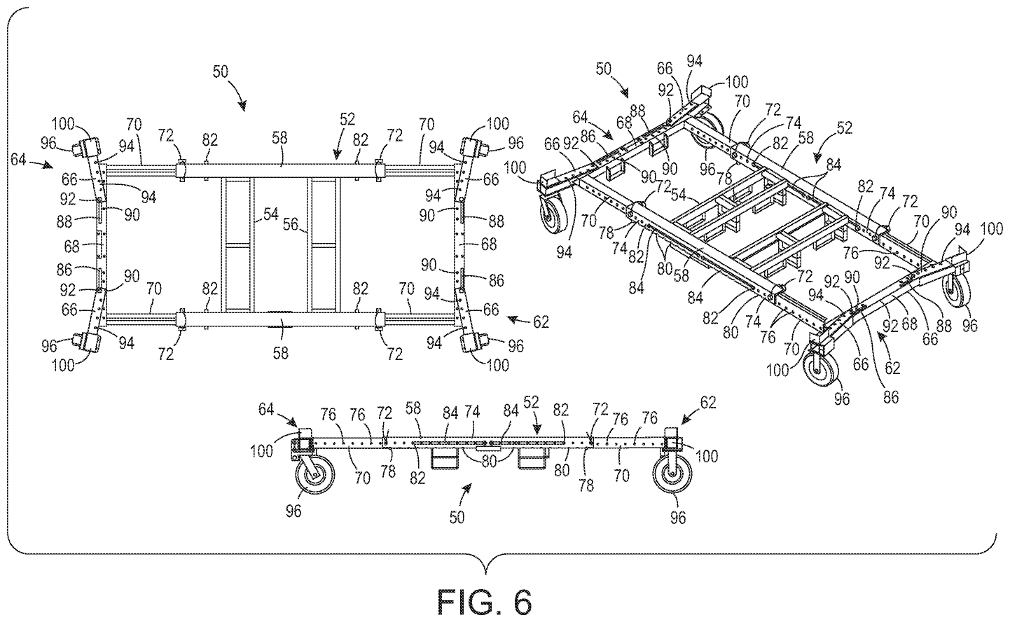

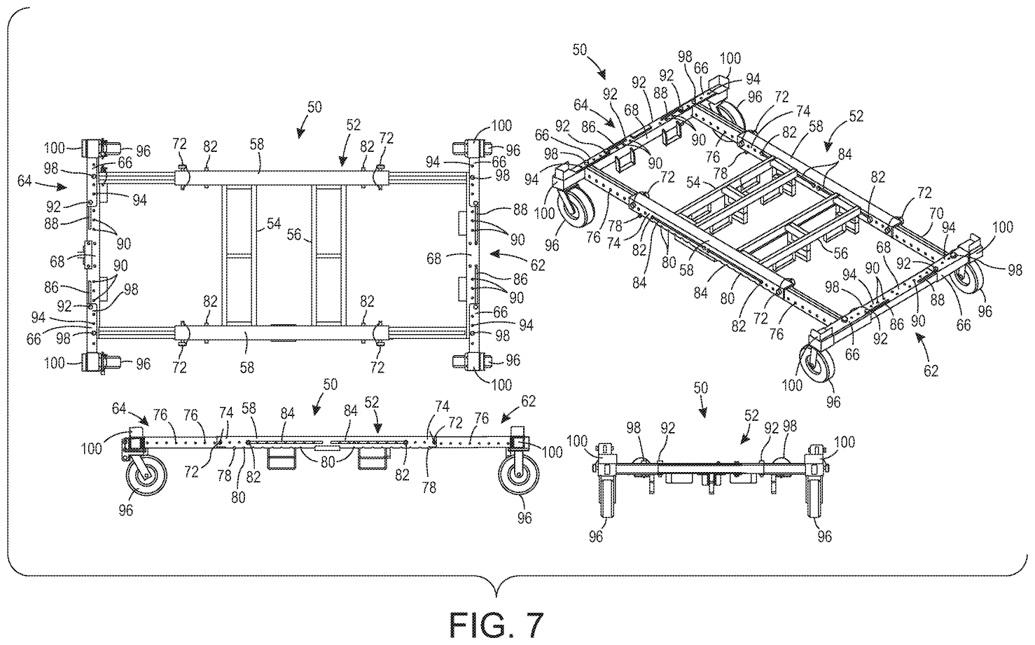

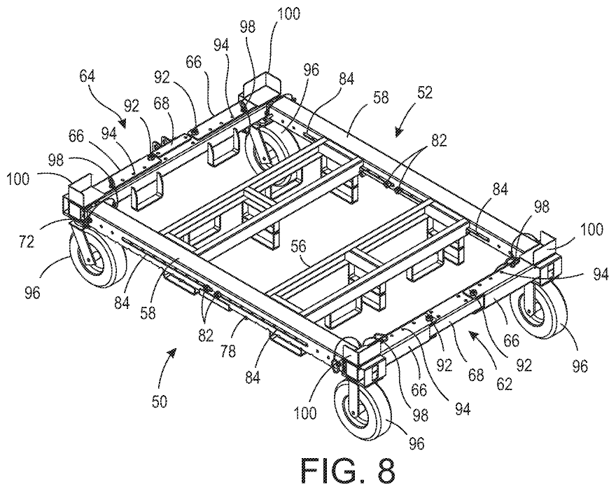

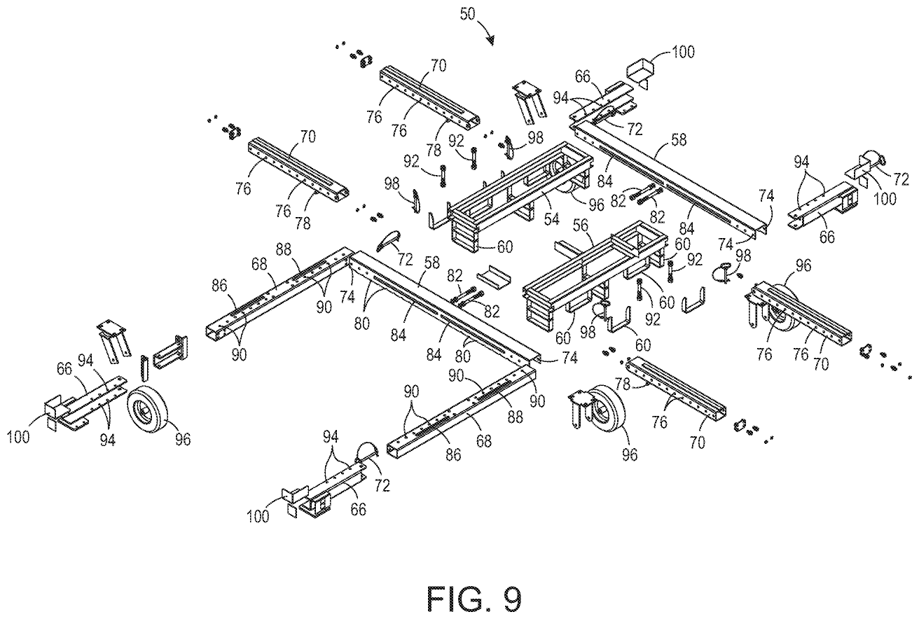

Adverting now to the figures, an embodiment of a present adjustable transport cart, i.e., adjustable cart 50, is depicted in FIGS. 1-9. It should be appreciated that although the depicted embodiments of adjustable cart 50 are symmetrical, some asymmetry is also possible, e.g., locations and configurations of the fork pockets described in greater detail below.

Adjustable cart 50 comprises main frame 52. Main frame 52 comprises cross supports 54 and 56 and side arms 58. Cross supports 54 and 56 further comprise fork pockets 60. Fork pockets 60 are arranged to permit the lifting of adjustable cart 50 by a forklift or similar device. Adjustable cart 50 may be lifted by a forklift to move cart 50 from a first location to a second location, or alternatively to lift cart 50 to facilitate the further adjustment of moveable ends 62 and 64 including outriggers 66. Cross supports 54 and 56 connect side arms 58 to form a generally ladder like arrangement, and create a fixed width and length for main frame 52.

Moveable ends 62 and 64 each comprise connecting bar 68, side bars 70 and outriggers 66. Each of side bars 70 independently interface with one of side arms 58. In order to move side bars 70 relative to side arms 58, and thus moveable ends 62 and 64 relative to main frame 52, hitch pin 72 is removed from locking hole 74 of side arm 58 which aligned with pin hole 76 of side bar 70 when moveable ends 62 and 64 are not positioned for linear travel. Next, side bars 70 are tilted downwardly such that pins 78 clear notches 80. Then pins 82 of side bars 70 may be moved linearly within slots 84 of side arms 58. Upon reaching the desired extension length, side bars 70 are pivoted upwardly until pin 78 reengages within one of notches 80. Lastly, hitch pin 72 is repositioned within one of locking holes 74 and an aligned pin hole 76. In view of the foregoing, it should be appreciated that side bars 70, and thus moveable ends 62 and 64, may be linearly translated within slots 84 to a desired extension distance, and that each moveable end 62 and 64 may be positioned at a unique distance relative to main frame 52, i.e., each moveable end 62 and 64 may be extended to a unique length. The same process is used to retract moveable ends 62 and 64 towards main frame 52.

Side arms 58 may include a plurality of notches 80 positioned along a lower edge of each side arm 58. The spacing between notches 80 can be selected based on the particular needs of an end user, e.g., notches may be spaced at three-inch increments so that adjustable cart 50 may be expanded or contracted a minimum amount of three inches. Other notch spacings are also possible, and fall within the scope of this application. Additionally, side arms 58 and side bars 70 may each include a plurality of locking holes 74 and pin holes 76, respectively. Thus, multiple hitch pins 72 may be used, or alternatively, a specific pair of holes must receive hitch pin 72, e.g., when side bars 70 are fully expanded, the outer most locking hole 74 and pin hole 76 may be the only holes remaining in alignment and capable of receiving hitch pin 72.

In addition to being expandable in front-to-back or forward-backward directions, adjustable cart 50 may also be expanded in lateral, side-to-side or left-right directions. Each connecting bar 68 comprises slots 86 and 88 and pin holes 90. Outriggers 66 each comprise pin 92, locking holes 94, and wheel 96. In order to move outriggers 66 relative to connecting bar 68, and thus outriggers 66 relative to main frame 52, hitch pin 98 is removed from locking hole 94 of outrigger 66 which aligned with pin hole 90 of connecting bar 68 when outriggers 66 are not positioned for linear travel. Next, outriggers 66 are pivoted outwardly. Then pins 92 of outriggers 66 may be moved linearly within slots 86 and 88 of connecting bar 68. Upon reaching the desired extension length, outriggers 66 are pivoted inwardly until one of locking holes 94 aligns with one of pin holes 90. Lastly, hitch pin 98 is repositioned within one of locking holes 94 and an aligned pin hole 90. In view of the foregoing, it should be appreciated that outriggers 66 may be linearly translated within slots 86 and 88 to a desired extension distance, and that each outrigger 66 may be positioned at a unique distance relative to main frame 52, i.e., each outrigger 66 may be extended to a unique length. The same process is used to retract outriggers 66 towards main frame 52. Additionally, connecting bars 68 may each include a plurality of pin holes 90, while outriggers 66 may each include a plurality of locking holes 94. Thus, multiple hitch pins 98 may be used, or alternatively, a specific pair of holes must receive hitch pin 98, e.g., when outriggers 66 are fully expanded, the outer most locking hole 94 and pin hole 90 may be the only holes remaining in alignment and capable of receiving hitch pin 98.

It should be appreciated that both forward-backward expansion and contraction, as well as lateral expansion and contraction can be accomplished without the need to first pivot or rotate the side bars and/or the outriggers. In short, those elements may be linearly translated relative to the main frame and connecting bar. Moreover, both forward-backward expansion and lateral expansion may be facilitated by lifting adjustable cart 50. So, for example, a fork lift may be engaged within fork pockets 60 and adjustable cart 50 can then be lifted. From a lifted position, the adjustment of side bars 70 and outriggers 66 may be more readily accomplished as the main frame does not restrict the adjustment.

It should be appreciated that in some embodiments, each outrigger 66 may further comprise corner capture 100. Corner capture 100 is arranged to receive and secure a corner of an article placed on adjustable cart 50. Thus, it should be appreciated that the combination of four corner captures 100 forms a means to securely position a rectangular shaped article on adjustable cart 50. Furthermore, depending on the end user's needs, the position of corner captures 100 relative to main frame 52 can be set to accommodate various sized articles and various transport needs, e.g., off center positioning of the article to permit clearance over or around existing physical constraints. Moreover, other receiving and article securing configurations are also possible, e.g., pins, and such configurations fall within the scope of this application.

In view of the foregoing, it should be appreciated that adjustable cart 50 can be modified to accommodate articles and/or racks of various sizes thereby permitting an end user to use a single cart to transport a greater variety of articles than previously possible. Thus, for example, one cart can be used to transport an article or rack as small as fifty-four inches wide by seventy-six inches long as well as articles or racks as large as seventy-eight inches wide by one hundred twenty-six inches long. It should be appreciated that some manufacturers first design a transport rack to accommodate varying types/sizes of parts, and the foregoing adjustable transport cart may be adjusted to the size of those transport racks as deemed necessary for cost effective manufacturing.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

50 Adjustable cart
52 Main frame
54 Cross support
56 Cross support
58 Side arms
60 Fork pockets
62 Moveable end
64 Moveable end
66 Outrigger
68 Connecting bar
70 Side bar
72 Hitch pin
74 Locking hole (in side arm 58)
76 Pin hole (in side bar 70)
78 Pin (engages with notches 82)
80 Notch
82 Pin (positioned within slot 84)
84 Slot (in side arms 58)
86 Slot (in connecting bar 68)
88 Slot (in connecting bar 68)
90 Pin hole (in connecting bar 68)
92 Pin (in outrigger 66)
94 Locking hole (in outrigger 66)
96 Wheel
98 Hitch pin
100 Corner capture

What is claimed is:

1. An adjustable cart, comprising:
a main frame, including a first side arm and at least one wheel; and
a first movable end, including:
a first connecting bar;
a first side bar connected to the first connecting bar, wherein the first side bar is slidably engaged with the side arm in order to adjust a length of the adjustable cart; and,
an outrigger connected to the first connecting bar.

2. The adjustable cart as recited in claim 1, wherein the outrigger is slideably connected to the first connecting bar to adjust a width of the adjustable cart.

3. The adjustable cart as recited in claim 2, wherein:
the outrigger comprises a first pin;
the first connecting bar comprises a first slot; and,
the first pin engages the first slot.

4. The adjustable cart as recited in claim 2, wherein:
the first connecting bar comprises a first plurality of pin holes;
the first outrigger comprises a first plurality of locking holes; and,
the first plurality of locking holes are operatively arranged to align with the first plurality of pin holes to lock the first outrigger and the first connecting bar.

5. The adjustable cart as recited in claim 1, wherein:
the first side bar comprises a first pin;
the first side arm comprises a first slot; and,
the first pin engages the first slot.

6. The adjustable cart as recited in claim 5, wherein the first side arm comprises a plurality of notches operatively arranged to engage with a locking pin arranged on the first side bar to lock the first side arm from slidable movement relative to the first side bar.

7. The adjustable cart as recited in claim 6, wherein, to adjust the length of the adjustable cart, the first side bar is rotated relative to the first side arm to disengage a notch of the plurality of notches from the locking pin.

8. The adjustable cart as recited in claim 1, wherein:
the first side bar comprises a first plurality of pin holes;
the first side arm comprises a first plurality of locking holes; and,
the first plurality of locking holes are operatively arranged to align with the first plurality of pin holes to lock the first side arm with respect to the first side bar.

9. The adjustable cart as recited in claim 1, wherein the main frame further comprises one or more cross supports.

10. The adjustable cart as recited in claim 1, wherein the main frame further comprises one or more fork pockets operatively arranged to engage forks of a forklift.

11. The adjustable cart as recited in claim 1, further comprising at least one corner capture connected to the outrigger.

12. An adjustable cart, comprising:
a main frame, including:
a first side arm having a first slot;
a second side arm having a second slot; and,
one or more wheels;
a first movable end, including:
a first connecting bar;
a first side bar connected to the first connecting bar, wherein the first side bar is slidably engaged with the first side arm in order to adjust a length of the adjustable cart;
a second side bar connected to the first connecting bar, wherein the second side bar is slidably engaged with the second side arm in order to adjust the length of the adjustable cart;
a first outrigger slidably connected to the first connecting bar to adjust a width of the adjustable cart; and,
a second outrigger slidably connected to the first connecting bar to adjust the width of the adjustable cart.

13. The adjustable cart as recited in claim 12, wherein:
the first outrigger comprises a first pin;
the first connecting bar comprises a first slot; and,
the first pin engages the first slot.

14. The adjustable cart as recited in claim 12, wherein:
the first connecting bar comprises a first plurality of pin holes;
the first outrigger comprises a first plurality of locking holes; and,
the first plurality of locking holes are operatively arranged to align with the first plurality of pin holes to lock the first outrigger and the first connecting bar.

15. The adjustable cart as recited in claim 12, wherein:
the first and second side bars comprise first and second pin, respectively;
the first and second side arms comprise first and second slots, respectively; and,
the first and second pins slidably engage the first and second slots.

16. The adjustable cart as recited in claim 15, wherein:
the first side bar comprises a locking pin; and,
the first side arm comprises a plurality of notches operatively arranged to engage with the locking pin to lock the first side arm from slidable movement relative to the first side bar.

17. The adjustable cart as recited in claim 16, wherein, to adjust the length of the adjustable cart, at least the first side bar is rotated relative to the first side arm to disengage a notch of the plurality of notches from the locking pin.

18. The adjustable cart as recited in claim 12, wherein:
the first side bar comprises a first plurality of pin holes;
the first side arm comprises a first plurality of locking holes; and,
the first plurality of locking holes are operatively arranged to align with the first plurality of pin holes to lock the first side arm with respect to the first side bar.

19. The adjustable cart as recited in claim 12, further comprising at least one corner capture connected to one of the first or second outrigger.

20. The adjustable cart as recited in claim 12, further comprising a second movable end, including:
a second connecting bar;
a third side bar connected to the second connecting bar, wherein the third side bar is slidably engaged with the first side arm in order to adjust the length of the adjustable cart;
a fourth side bar connected to the second connecting bar, wherein the fourth side bar is slidably engaged with the second side arm in order to adjust the length of the adjustable cart;
a third outrigger slidably connected to the second connecting bar to adjust the width of the adjustable cart; and,
a fourth outrigger slidably connected to the second connecting bar to adjust the width of the adjustable cart.
